(19) United States
(12) Patent Application Publication
(10) Pub. No.: US 2024/0317612 A1
(43) Pub. Date: Sep. 26, 2024

(54) METHODS UTILIZING ACTIVE QUANTUM CHEMISTRY

(71) Applicant: Jerome Ramsey, Blair, NE (US)

(72) Inventor: Jerome Ramsey, Blair, NE (US)

(21) Appl. No.: 18/124,843

(22) Filed: Mar. 22, 2023

(51) Int. Cl. C02F 1/30; B01J 19/08; B01J 19/24; C01B 21/16; C01C 1/04; C02F 1/461; C25B 1/04; C25B 1/55; C25B 9/19

(52) U.S. Cl. CPC C02F 1/30; B01J 19/088; B01J 19/2475; C01B 21/16; C01C 1/0417; C02F 1/46104; C25B 1/04; C25B 1/55; C25B 9/19; B01J 2219/0809; B01J 2219/085; C02F 2103/08; C02F 2201/46115

(57) ABSTRACT

Described herein are methods of chemical reactions using active quantum chemistry. The methods are optimized and apply energies more directly and more efficiently, compared to conventional chemical reactions, in order to cause and/or promote chemical reactions.

### BACKGROUND

Conventional chemical reactions require large energy inputs. These large energy inputs limit efficiencies and result in non-specific reactions. In addition, inefficient conversion processes can waste energy as unusable, light, sound, and/or heat.

In contrast, reactions that utilize active quantum chemistry (AQC) are more specific and controlled than conventional reactions. AQC methods apply specific electromagnetic energies, known as quantum energies, to chemical reactants in order to drive chemical reactions. One known way to apply quantum energies using AQC is by photochemistry. Photochemical reactions are a type of AQC in which bands of electromagnetic energies are applied to a chemical system. However, many photochemical reactions apply the full spectrum of visible light and are not optimized.

The AQC methods described herein are optimized and excite electrons into higher orbital clouds and/or different electron energy levels. These AQC methods specifically target individual electrons or groups of electrons, while leaving electrons at other energy levels unaltered. In this way, the AQC methods place atoms and molecules into differing quantum states. These quantum states effect subsequent changes. These quantum states may be used to make or break chemical bonds and/or as a precursor to make or break chemical bonds.

The AQC methods described herein possess high conversion rates because less energy is wasted as unusable energy. Heat is not used to move atoms and molecules or to excite electrons. Rather, the AQC methods target and excite electrons at specific energy levels to new energy levels.

The AQC methods described herein apply energies more directly and more efficiently to cause and/or promote chemical reactions. The AQC methods are capable of synthesizing fuels and chemicals with little heat, little pressure, and reduced costs. Accordingly, the AQC methods described herein advance the field of chemical reactions.

### BRIEF DESCRIPTION

In one aspect, a method of producing at least one chemical product is provided. The method includes subjecting at least one chemical reactant to a quantum energy, wherein the quantum energy selectively reacts the at least one chemical reactant to produce the at least one chemical product.

### DETAILED DESCRIPTION

The embodiments described herein overcome at least some of the disadvantages of known chemical reactions. The AQC methods described herein are proper and utilize proper quantum states. In proper quantum states, atoms and molecules may be made to wiggle, to wobble, and/or move. In proper quantum states, atoms and molecules may be positively or negatively ionized. In proper quantum states, electrons may be energized and atoms or molecules may reconfigure in response to the quantum energy levels. In proper quantum states, atoms or molecules may react to form desired products. In proper quantum states, materials at the molecular level may structure or polar align to a temporary material phase. The proper quantum states may be optimized.

In many embodiments, the method includes subjecting at least one chemical reactant to a quantum energy, wherein the quantum energy selectively reacts the at least one chemical reactant to produce the at least one chemical product. In some embodiments, the quantum energy is a proper quantum energy to selectively react the at least one chemical reactant to produce the at least one chemical product. In some embodiments, the quantum energy is optimized to selectively react the at least one chemical reactant to produce the at least one chemical product.

In the method, an element can be energized (e.g., electrically) to produce that element's full emission and absorption spectrum. This full elemental spectrum is the super-set of quantum energies needed to achieve the desired quantum state. Differing quantum states may be applied to the at least one reactant (e.g. N₂). These differing quantum states put the at least one reactant (e.g. N₂) into a favorable reactive state, such that the at least one reactant can be combined with other reactants (e.g., H₂), including other reactants that have similarly been exposed to quantum energies and therefore possess differing quantum states. The reactants may be combined and reacted to form valuable products (e.g., NH₃).

The necessary quantum energies for energization may be found in the combined absorption and emission spectra. These energies may be applied with a variety of techniques, including by splitting emission spectra, variable frequency lights, variable frequency lasers, or other light emitting devices. Similarly, other devices can emit sufficient and specific electromagnetic energy. Such devices include light emitting diodes (LEDs), electrical coils, and magnetic devices.

The proper quantum energies may be experimentally identified and/or confirmed. For example, the absorption energy frequencies are known for both hydrogen and nitrogen. Longer wavelengths in the third of visible light energies up into microwave energies energize the valence electrons needed for reactions. After these quantum energies are identified, a more efficient process can be performed by emitting the optimized quantum energies (e.g. with one or more light-emitting devices). For example, light emitting diodes or other devices constructed to singularly emit the needed quantum energy frequencies can be used for emission.

Generally, molecules are made from the bonding of valence electrons. It is these electrons that form covalent and ionic bonds. AQC quantum energies with lower energies and longer wavelengths from visible light to microwave light excite valence electrons, in contrast to other methods that use higher energies that excite inner electrons.

Generally, the quantum energies may be any suitable energies known in the art that facilitates the methods described herein. In some embodiments, the quantum energies include energies selected from the group consisting of gamma ray energies, x-ray energies, ultraviolet energies, visible energies, infrared energies, microwave energies, radio wave energies, energies from electric fields, energies from magnetic fields, and combinations thereof. In some embodiments, the quantum energies include an energy with a wavelength selected from the group consisting of gamma ray energy wavelengths, x-ray energy wavelengths, ultraviolet energy wavelengths, visible energy wavelengths, infrared energy wavelengths, microwave energy wavelengths, radio wave energy wavelengths, wavelengths from electric fields, wavelengths from magnetic fields, and combinations thereof.

Generally, the quantum energies may be applied with any suitable energy application device known in the art that facilitates the methods described herein. In some embodiments, the quantum energies are applied with an energy application device selected from the group consisting of light emitting devices, lights, lasers, light emitting diodes, electrical coils, magnetic devices, electric field generating devices, magnetic field generating devices, anodes, cathodes, and combinations thereof. In some embodiments, the energy application device is a light emitting diode. Light emitting diodes are particularly advantageous because they have a large range of wavelengths and the ability to emit precise spectral quantum energies (e.g. spectral energy at 400.67 nm).

In some embodiments, the method further includes ionizing the at least one chemical reactant. Ions are created by either adding or removing electrons from a balanced atom or molecule. Negative ions can be formed by increasing the distance between the positive atomic nucleus and negative electrons. AQC quantum energies may excite electrons into higher energy clouds, forcing the addition of other electrons to keep the charges balanced. Positive ions are created by stripping one or more electrons. For example, the solar photovoltaic effect strips electrons with the quantum energies in sunlight. The benefits of ions include their attraction to opposite charges, their ability to react to cancel their charges, and the ability to move ions in a magnetic field.

In some embodiments, the at least one chemical reactant is present in a mixture. In some embodiments, the at least one chemical reactant is present in a gaseous mixture. In some embodiments, the at least one chemical reactant is present in a liquid mixture. In some embodiments, the at least one chemical reactant is present in a mixture including at least one liquid and at least one gas.

In some embodiments, the at least one chemical reactant is present in a mixture including a component that does not react when the at least one chemical reactant is subjected to a quantum energy. In these embodiments, the selectivity of the quantum energy drives the desired chemical reaction without undesired reactions.

In some embodiments, the mixture is air. Air includes about 79% nitrogen and 20% oxygen. In these embodiments, the nitrogen and/or oxygen in air can react with subsequent mixing and reacting with other reactants. For example, nitrogen ions from air may react with hydrogen ions to form ammonia.

In some embodiments, the at least one chemical reactant includes at least two chemical reactants. In some embodiments, the at least two chemical reactants are in differing quantum states. As used herein, a quantum state refers to the state that electrons are forced into by quantum excitation. Two different reactants may be forced into two different electron probability densities. These different electron probability densities cause electrons to align, thereby causing a percentage of the two different reactants to bond, resulting in the desired reaction.

Generally, the at least one chemical reactant may include any reactant known in the art that facilitates the methods described herein. In some embodiments, the at least one chemical reactant is selected from the group consisting of air, N₂, H₂, O₂, H₂O, non-pure H₂O, hydrophilic surfaces, atoms thereof, ions thereof, and combinations thereof.

Generally, the at least one chemical product may include any product known in the art that facilitates the methods described herein. In some embodiments, the at least one chemical product is selected from the group consisting of N₂H₄, NH₃, H₂, O₂, pure H₂O, atoms thereof, ions thereof, and combinations thereof.

In some embodiments, the at least one chemical reactant includes N₂ and H₂ and the at least one chemical product includes N₂H₄.

In some embodiments, the at least one chemical reactant includes N₂ and H₂ and the at least one chemical product includes NH₃.

In some embodiments, the at least one chemical reactant includes H₂O and the at least one chemical product includes H₂ and O₂.

In some embodiments, the at least one chemical reactant includes non-pure H₂O and the at least one chemical product includes pure H₂O.

In some embodiments, the at least one chemical product is not further subjected to purification by a filter.

In some embodiments, the at least one chemical reactant is subjected to the quantum energy in a reactor. Generally, the reactor may include any reactor component known in the art that facilitates the methods described herein.

In some embodiments, the reactor includes a component selected from the group consisting of a gaseous reaction vessel, a liquid collection vessel, an energy application device, a cathode, an anode, a proton exchange membrane, a magnet configured to move ions, and combinations thereof.

In some embodiments, the reactor further includes a super hydrophilic surface configured for polar alignment of the at least one reactant.

Further aspects of the present disclosure are provided by the subject matter of the following clauses:
1. A method of producing at least one chemical product comprising:
subjecting at least one chemical reactant to a quantum energy;
wherein the quantum energy selectively reacts the at least one chemical reactant to produce the at least one chemical product.
2. The method in accordance with the preceding clause, wherein the quantum energy is optimized to selectively react the at least one chemical reactant to produce the at least one chemical product.
3. The method in accordance with any preceding clause, further comprising determining the quantum energy that selectively reacts the at least one chemical reactant to produce the at least one chemical product prior to subjecting the at least one chemical reactant to the quantum energy.
4. The method in accordance with any preceding clause, further comprising ionizing the at least one chemical reactant.
5. The method in accordance with any preceding clause, wherein the at least one chemical reactant is present in a mixture.
6. The method in accordance with any preceding clause, wherein the at least one chemical reactant is present in a mixture comprising a component that does not react when the at least one chemical reactant is subjected to a quantum energy.
7. The method in accordance with any preceding clause, wherein the at least one chemical reactant is present in a gaseous mixture.
8. The method in accordance with any preceding clause, wherein the quantum energy is applied with an energy application device selected from the group consisting of light emitting devices, lights, lasers, light emitting diodes, electrical coils, magnetic devices, electric field generating devices, magnetic field generating devices, anodes, cathodes, and combinations thereof.
9. The method in accordance with any preceding clause, wherein the quantum energy comprises an energy selected from the group consisting of gamma ray energies, x-ray energies, ultraviolet energies, visible energies, infrared energies, microwave energies, radio wave energies, energies from electric fields, energies from magnetic fields, and combinations thereof.
10. The method in accordance with any preceding clause, wherein the quantum energy comprises an energy with a wavelength selected from the group consisting of gamma ray energy wavelengths, x-ray energy wavelengths, ultraviolet energy wavelengths, visible energy wavelengths, infrared energy wavelengths, microwave energy wavelengths, radio wave energy wavelengths, wavelengths from electric fields, wavelengths from magnetic fields, and combinations thereof.
11. The method in accordance with any preceding clause, wherein the at least one chemical reactant comprises at least two chemical reactants, wherein the at least two chemical reactants are in differing quantum states.
12. The method in accordance with any preceding clause, wherein the at least one chemical reactant is selected from the group consisting of air, N₂, H₂, O₂, H₂O, non-pure H₂O, hydrophilic surfaces, atoms thereof, ions thereof, and combinations thereof.
13. The method in accordance with any preceding clause, wherein the at least one chemical product is selected from the group consisting of N₂H₄, NH₃, H₂, O₂, pure H₂O, atoms thereof, ions thereof, and combinations thereof.
14. The method in accordance with any preceding clause, wherein the at least one chemical reactant comprises N₂ and H₂ and the at least one chemical product comprises N₂H₄.
15. The method in accordance with any preceding clause, wherein the at least one chemical reactant comprises N₂ and H₂ and the at least one chemical product comprises NH₃.
16. The method in accordance with any preceding clause, wherein the at least one chemical reactant comprises H₂O and the at least one chemical product comprises H₂ and O₂.
17. The method in accordance with any preceding clause, wherein the at least one chemical reactant comprises non-pure H₂O and the at least one chemical product comprises pure H₂O.
18. The method in accordance with any preceding clause, wherein the at least one chemical product is not further subjected to purification by a filter.
19. The method in accordance with any preceding clause, wherein the at least one chemical reactant is subjected to the quantum energy in a reactor, and wherein the reactor comprises a component selected from the group consisting of a gaseous reaction vessel, a liquid collection vessel, an energy application device, a cathode, an anode, a proton exchange membrane, a magnet configured to move ions, and combinations thereof.
20. The method in accordance with any preceding clause, wherein the reactor further comprises a super hydrophilic surface configured for polar alignment of the at least one reactant.

References to “some embodiments” in the above description are not intended to be interpreted as excluding the existence of additional embodiments that also incorporate the recited features.

### EXAMPLES

Without further elaboration, it is believed that one skilled in the art using the preceding description can utilize the present invention to its fullest extent. The following Examples are, therefore, to be construed as merely illustrative, and not limiting of the disclosure in any way whatsoever. The starting material for the following Examples may not have necessarily been prepared by a particular preparative run whose procedure is described in other Examples. It also is understood that any numerical range recited herein includes all values from the lower value to the upper value. For example, if a range is stated as 10-50, it is intended that values such as 12-30, 20-40, or 30-50, etc., are expressly enumerated in this specification. These are only examples of what is specifically intended, and all possible combinations of numerical values between and including the lowest value and the highest value enumerated are to be considered to be expressly stated in this application.

### Example 1. Synthesis of Hydrazine

Hydrazine (N₂H₄) may be synthesized from N₂ and H₂ using AQC. In particular N₂ and H₂ may be mixed in proper proportions and energized with differing quantum energies.

N₂ possesses a triple bond including six electrons; two in a sigma bond and four in two pi bonds. The two pi bonds can be specifically targeted. N₂ is bathed in quantum energies (e.g. pulsed quantum energies) to specifically energize the four electrons in the pi bonds. As the electrons reach higher energies, the two pi bonds break and the four electrons begin to align in excited P orbital clouds.

H₂ possesses a single bond including two electrons. Like N₂, H₂ may be bathed in pulsing quantum energies to energize its two electrons. The two hydrogen protons move apart at higher energy levels as its electrons also achieve higher energy.

With proper quantum energy and optionally pressure, the energized electrons from N₂ and H₂ associate, thereby forming electron bonds. The N₂ and H₂ associate to form hydrazine. Liquid hydrazine forms from the N₂ and H₂ gasses. At the bottom of the AQC hydrazine reactor, excess quantum energy is released as the molecules fall to a stable energy configuration.

The energy stored in hydrazine may be useful in fuel cells or home energy. For example, hydrazine may be used as a fuel in an alkaline fuel cell. The fuel cell may be a solid ceramic iron aluminum oxide fuel cell in order to possess high conversion efficiencies. Hydrazine is a liquid, carbon free fuel that may be used as a fuel source, including for homes, cars, trucks, trains, and airplanes. It may also be used as a fuel to store energy (e.g., for seconds or decades). Fifteen gallons of hydrazine holds about 300 Kilowatt hours of power: in this way a 75% efficient alkaline fuel cell provides 400 to 450 miles range in a midsize car, or over 45 days solar backup.

### Example 2. Synthesis of Ammonia

Ammonia (NH₃) may be synthesized from N₂ and H₂ using AQC. In particular N₂ and H₂ may be mixed in proper proportions, energized with differing quantum energies, and then ionized. Differing ionic charges occur because of the quantum energies.

An ammonia reactor may include an anode, such as an iron wool anode or carbon wool anode. The anode may be a gas permeable anode. Nitrogen molecules accept electrons at the anode because the three valence electron are excited by AQC to high energies. The energies are not high enough to remove the electrons, but are high enough to affect the electrons distance (i.e., square of the distance) at which nitrogen's electronegativity allows a gas permeable anode to complete the nitrogen orbital clouds, thereby creating nitrogen anions. Nitrogen ions may be subsequently moved by magnetic fields through the anode.

An ammonia reactor may include a cathode including a proton exchange membrane. Hydrogen molecules may reduce and give up their electrons at the cathode without AQC, but the affinity to give up these electrons is increased because AQC places these electrons into higher energy levels.

Both nitrogen ions and hydrogen ions may be magnetically moved into a reaction chamber. Ammonia is synthesized when these opposing ions mix and reaction. Liquid ammonia may form from the gasses with 10 bars of pressure.

Ammonia is a known and vital chemical. It is most commonly produced with the Haber-Bosch process. However, synthesis of ammonia with AQC allows the production of anhydrous ammonia at industrial scales, individual scales, and intermediate scales there between.

Ammonia produced by AQC may be used for the same purposes as ammonia produced from other processes. For example, it may be used as a fertilizer, coolant, and to store energy (e.g., as a reactant to produce H₂).

### Example 3. Water Purification

Pure water may be produced from a non-pure water source (e.g., seawater) using AQC. In particular, quantum energy is applied to the non-pure water source in order to produce structured water on a super hydrophilic surface. This layer of structured water grows many microns thick as quantum energy is added and more H₂O molecules align according to polarity. The impurities are pushed beyond the edge of the layer of structured water. The structured water, made from purified H₂O, is harvested after draining the impure water and discontinuing the quantum energies, which allows the H₂O molecules to dis-align and flow. Notably, the purified H₂O does not require further purification (e.g., with a filter and high pressures) because this process produces pure H₂O.

Pure water may also be produced from a non-pure water source (e.g., seawater) by applying quantum energies to small water purification tubes including internal hydrophilic surfaces. The combination of the capillary effect and quantum energies pulls pure H₂O through each straw when the straw is partially submerged in the non-pure water source.

Several quantum energies may cause H₂O to polar align with a hydrophilic surface. Such energies range from infrared energies to microwave energies. This polar alignment is a secondary effect of hydrophilic surfaces holding the contact molecules: AQC adds energy to non-contact molecules causing them to wiggle, wobble, and move until they align such that only the quantum energy holds them in alignment.

### Example 4. Electrolysis

Water may be electrolyzed using AQC. In particular, AQC electrolysis uses a super hydrophilic anode (e.g., a laser-etched super hydrophilic anode) and cathode surfaces separated by a proton exchange membrane (PEM). Super hydrophilic surfaces combined with quantum energies cause H₂O molecules to polar align on each electrode growing towards the center membrane.

The ion zone begins on the anode side at the edge of the aligning H₂O molecules. Here, the oxygen in an H₂O molecule gives up one or two hydrogen protons and accepts one or two electrons. With pure H₂O, the ion zone has three differing ions: oxygen atom ions (O⁻²), hydrogen atom ions (H⁺), and hydroxide molecule ions (OH⁻). Both alignment zones grow and the ion zone builds ions with the addition of proper quantum energies. Ions forced out of the aligning H₂O molecules zone are pushed to the center PEM where hydrogen is pulled across the PEM by cathode attraction forces. Quantum energies may be pulsed to keep ether alignment zone from reaching the center PEM.

The affinity to create ions is enhanced by the same quantum energies that cause H₂O molecule to wiggle, wobble and align. Quantum energy may be directed at hydroxide molecules increasing its affinity to break into its two ions.

The anode and cathode may both be extended by the aligning H₂O molecules. Diatomic oxygen and diatomic hydrogen form at these moving, pulsing edges. These edges have at least two positive effects. First, they keep positive hydrogen ions and negative oxygen ions from collecting on the anode and cathode, thereby keeping impedance low. Second, they move oxygen, hydroxide and hydrogen ions to the center. Diatomic oxygen may effervesce from a smaller, pulsing edge. Hydroxide ions area is also smaller and pushes toward the center PEM. Hydrogen ions are in the center and easily cross the PEM to form diatomic hydrogen along a pulsing edge.

Unless otherwise indicated, approximating language, such as “generally,” “substantially,” and “about,” as used herein indicates that the term so modified may apply to only an approximate degree, as would be recognized by one of ordinary skill in the art, rather than to an absolute or perfect degree. Accordingly, a value modified by a term or terms such as “about,” “approximately,” and “substantially” is not to be limited to the precise value specified. In at least some instances, the approximating language may correspond to the precision of an instrument for measuring the value. Additionally, unless otherwise indicated, the terms “first,” “second,” etc. are used herein merely as labels, and are not intended to impose ordinal, positional, or hierarchical requirements on the items to which these terms refer. Moreover, reference to, for example, a “second” item does not require or preclude the existence of, for example, a “first” or lower-numbered item or a “third” or higher-numbered item.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal languages of the claims.

What is claimed is:

1. A method of producing at least one chemical product comprising:
subjecting at least one chemical reactant to a quantum energy;
wherein the quantum energy selectively reacts the at least one chemical reactant to produce the at least one chemical product.

2. The method of claim 1, wherein the quantum energy is optimized to selectively react the at least one chemical reactant to produce the at least one chemical product.

3. The method of claim 1, further comprising determining the quantum energy that selectively reacts the at least one chemical reactant to produce the at least one chemical product prior to subjecting the at least one chemical reactant to the quantum energy.

4. The method of claim 1, further comprising ionizing the at least one chemical reactant.

5. The method of claim 1, wherein the at least one chemical reactant is present in a mixture.

6. The method of claim 1, wherein the at least one chemical reactant is present in a mixture comprising a component that does not react when the at least one chemical reactant is subjected to a quantum energy.

7. The method of claim 1, wherein the at least one chemical reactant is present in a gaseous mixture.

8. The method of claim 1, wherein the quantum energy is applied with an energy application device selected from the group consisting of light emitting devices, lights, lasers, light emitting diodes, electrical coils, magnetic devices, electric field generating devices, magnetic field generating devices, anodes, cathodes, and combinations thereof.

9. The method of claim 1, wherein the quantum energy comprises an energy selected from the group consisting of gamma ray energies, x-ray energies, ultraviolet energies, visible energies, infrared energies, microwave energies, radio wave energies, energies from electric fields, energies from magnetic fields, and combinations thereof.

10. The method of claim 1, wherein the quantum energy comprises an energy with a wavelength selected from the group consisting of gamma ray energy wavelengths, x-ray energy wavelengths, ultraviolet energy wavelengths, visible energy wavelengths, infrared energy wavelengths, microwave energy wavelengths, radio wave energy wavelengths, wavelengths from electric fields, wavelengths from magnetic fields, and combinations thereof.

11. The method of claim 1, wherein the at least one chemical reactant comprises at least two chemical reactants, wherein the at least two chemical reactants are in differing quantum states.

12. The method of claim 1, wherein the at least one chemical reactant is selected from the group consisting of air, N₂, H₂, O₂, H₂O, non-pure H₂O, hydrophilic surfaces, atoms thereof, ions thereof, and combinations thereof.

13. The method of claim 1, wherein the at least one chemical product is selected from the group consisting of N₂H₄, NH₃, H₂, O₂, pure H₂O, atoms thereof, ions thereof, and combinations thereof.

14. The method of claim 1, wherein the at least one chemical reactant comprises N₂ and H₂ and the at least one chemical product comprises N₂H₄.

15. The method of claim 1, wherein the at least one chemical reactant comprises N₂ and H₂ and the at least one chemical product comprises NH₃.

16. The method of claim 1, wherein the at least one chemical reactant comprises H₂O and the at least one chemical product comprises H₂ and O₂.

17. The method of claim 1, wherein the at least one chemical reactant comprises non-pure H₂O and the at least one chemical product comprises pure H₂O.

18. The method of claim 17, wherein the at least one chemical product is not further subjected to purification by a filter.

19. The method of claim 1, wherein the at least one chemical reactant is subjected to the quantum energy in a reactor, and wherein the reactor comprises a component selected from the group consisting of a gaseous reaction vessel, a liquid collection vessel, an energy application device, a cathode, an anode, a proton exchange membrane, a magnet configured to move ions, and combinations thereof.

20. The method of claim 19, wherein the reactor further comprises a super hydrophilic surface configured for polar alignment of the at least one reactant.
